(19) United States
(12) Patent Application Publication
(10) Pub. No.: US 2013/0280010 A1
(43) Pub. Date: Oct. 24, 2013

(54) WATERPROOF SCREW, SEALING MATERIAL, METHOD FOR STRUCTURE INSTALLATION, AND STRUCTURE FOR STRUCTURE INSTALLATION

(71) Applicants: Hiroki Fujii, Osaka (JP); Tetsuro Taga, Osaka (JP); Yoshiaki Mitsuoka, Osaka (JP)

(72) Inventors: Hiroki Fujii, Osaka (JP); Tetsuro Taga, Osaka (JP); Yoshiaki Mitsuoka, Osaka (JP)

(73) Assignee: NITTO DENKO CORPORATION, Osaka (JP)

(21) Appl. No.: 13/994,423

(22) PCT Filed: Dec. 16, 2011
(86) PCT No.: PCT/JP2011/079160

§ 371 Date: Jun. 14, 2013

(30) Foreign Application Priority Data
Dec. 16, 2010 (JP) 2010280327
Dec. 8, 2011 (JP) 2011268728

(51) Int. Cl. F16B 35/00; F16B 43/00

(52) U.S. Cl. CPC F16B 35/00; F16B 43/001
USPC 411/371.1; 277/650

(57) ABSTRACT

A waterproof screw includes a screw member including a head portion and a shank portion and a sealing material covering the circumference of the shank portion. The sealing material has a shear storage elastic modulus G′ at 25° C. and a frequency of 1 Hz of 50000 Pa or less.

### TECHNICAL FIELD

The present invention relates to a waterproof screw, a sealing material, a method for structure installation, and a structure for structure installation, to be specific, to a waterproof screw used to install a structure on a roof of a building or the like, a sealing material, and a method for structure installation, and a structure for structure installation.

### BACKGROUND ART

A structure such as a solar cell module is usually fixed to a roof of a building by a screw.

Thus, there may be a case where rain water or the like infiltrates through a screw hole formed in the roof into the inside of the roof, so that the roof is corroded.

In this way, a waterproof screw that is capable of fixing a structure and suppressing infiltration of water into the inside of a roof has been variously considered.

As such a waterproof screw, a screw having a rubber elastic material for water proof in its head portion has been proposed (ref: for example, the following Patent Document 1).

### PRIOR ART DOCUMENT

### Patent Document

Patent Document 1: Japanese Unexamined Patent Publication No. 2006-74068

### SUMMARY OF THE INVENTION

### Problems to be solved by the Invention

Even when the structure is fixed to the roof using the screw described in the above-described Patent Document 1, however, there is a disadvantage that the rubber elastic material for water proof only seals the upper surface of the screw hole formed in the roof and fails to seal an insertion portion in the roof for the screw, so that the infiltration of water into the inside of the roof is not capable of being sufficiently suppressed.

It is an object of the present invention to provide a waterproof screw that is capable of fixing a structure to a roof; sealing an insertion portion for a shank portion; and sufficiently suppressing infiltration of water into the inside of the roof, a sealing material, a method for structure installation, and a structure for structure installation.

### Solution to the Problems

A waterproof screw of the present invention includes a screw member including a head portion and a shank portion and a sealing material covering the circumference of the shank portion, wherein the sealing material has a shear storage elastic modulus G′ at 25° C. and a frequency of 1 Hz of 50000 Pa or less.

In the waterproof screw of the present invention, it is preferable that the waterproof screw is used so as to install a structure on a roof.

In the waterproof screw of the present invention, it is preferable that the sealing material contains a butyl rubber and a liquid rubber.

In the waterproof screw of the present invention, it is preferable that the sealing material further contains a filler and the mixing ratio of the filler with respect to 100 parts by mass of the butyl rubber is less than 300 parts by mass.

In the waterproof screw of the present invention, it is preferable that the sealing material further contains a tackifier.

A sealing material of the present invention covers a shank portion of a screw member to be used so as to seal an insertion portion for the shank portion, wherein the sealing material has a shear storage elastic modulus G′ at 25° C. and a frequency of 1 Hz of 50000 Pa or less.

A method for structure installation of the present invention, installing a structure on a roof, includes the steps of disposing the structure on the roof and fixing the structure to the roof by the above-described waterproof screw.

A structure for structure installation of the present invention in which a structure is installed on a roof, wherein the structure is disposed on the roof and the structure is fixed to the roof by the above-described waterproof screw.

### Effect of the Invention

The waterproof screw of the present invention includes a screw member including a head portion and a shank portion and a sealing material covering the circumference of the shank portion, and the sealing material has a shear storage elastic modulus G′ at 25° C. and a frequency of 1 Hz of 50000 Pa or less. Thus, when a structure is fixed to a roof using the waterproof screw of the present invention, the sealing material is capable of sealing an insertion portion in the roof for the shank portion, so that infiltration of water into the inside of the roof is capable of being sufficiently suppressed.

Consequently, the waterproof screw, the sealing material, the method for structure installation, and the structure for structure installation of the present invention are capable of fixing the structure to the roof and sufficiently suppressing the infiltration of water into the inside of the roof.

### BRIEF DESCRIPTION OF THE DRAWINGS

FIG. 1 shows a side sectional view of one embodiment of a waterproof screw of the present invention.

FIG. 2 shows a side view of one embodiment of a sealing material used in a waterproof screw of the present invention.

FIG. 3 shows a side view of another embodiment (an embodiment including a support layer) of a sealing material used in a waterproof screw of the present invention.

FIG. 4 shows a side view of another embodiment (an embodiment including an elastic layer) of a sealing material used in a waterproof screw of the present invention.

FIG. 5 shows explanatory views for illustrating one embodiment of a method for structure installation of the present invention in which a structure is installed on a roof of a building:

(a): illustrating a step of disposing the structure on the roof (a structure disposing step) and

(b) to (e): illustrating a step of fixing the structure to the roof by the waterproof screw shown in FIG. 1 (a structure fixing step).

FIG. 6 shows explanatory views for illustrating evaluation criteria in a screw adhesiveness test:

(a) illustrating a case of having a good screw adhesiveness and

(b) illustrating a case of having a bad screw adhesiveness.

FIG. 7 shows explanatory views for illustrating evaluation criteria in a roofing material adhesiveness test:

(a) illustrating a case of having a good roofing material adhesiveness and

(b) illustrating a case of having a bad roofing material adhesiveness.

FIG. 8 shows an explanatory view for illustrating a test method of a water stopping test of screw in Examples and Comparative Examples.

### EMBODIMENT OF THE INVENTION

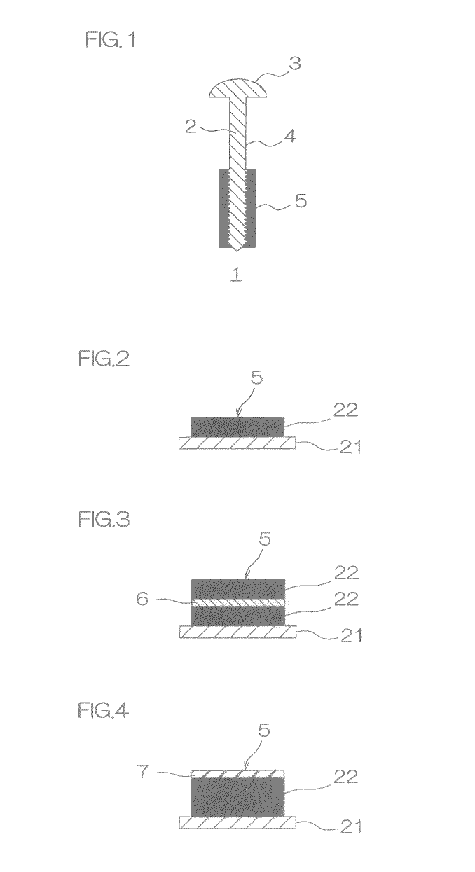

FIG. 1 shows a side sectional view of one embodiment of a waterproof screw of the present invention.

A waterproof screw 1 is a screw having a waterproof function that prevents infiltration of water into the inside of a screw hole. The waterproof screw 1 includes a screw member 2 and a sealing material 5.

The screw member 2 is a known screw member that is provided with a head portion 3 and a shank portion 4 at which a screw thread (a screw groove) is formed. The screw member 2 is not particularly limited and examples thereof include a wood screw and a metal screw. Preferably, a metal screw is used.

The sealing material 5 is used so as to cover the circumference of the shank portion 4 of the screw member 2 and to seal an insertion portion for the shank portion 4. The sealing material 5 has a shear storage elastic modulus G′ at 25° C. and a frequency of 1 Hz of 50000 Pa or less, or preferably 40000 Pa or less, and of, for example, 10000 Pa or more, or preferably 15000 Pa or more.

The shear storage elastic modulus G′ is calculated by a viscoelasticity test to be described in detail in Examples.

The sealing material 5 has a shear loss elastic modulus G″ at 25° C. and a frequency of 1 Hz of, for example, 5000 to 20000 Pa, or preferably 10000 to 18000 Pa.

The shear loss elastic modulus G″ is calculated with the above-described shear storage elastic modulus G′.

The sealing material 5 preferably contains a butyl rubber and a liquid rubber.

The butyl rubber is a copolymer (an isobutylene-isoprene rubber) of isobutene (isobutylene) and a small amount of isoprene.

The butyl rubber has a Mooney viscosity of, for example, 30 to 70 (ML 1+4, 100° C.), or preferably 40 to 60 (ML 1+4, 100° C.).

An example of the butyl rubber includes a known butyl rubber such as a reclaimed butyl rubber.

The mixing ratio of the butyl rubber with respect to the total amount of the sealing material is, for example, 10 to 50 mass %, or preferably 20 to 40 mass %.

The liquid rubber is a rubber in a liquid state at normal temperature that is compatible with the butyl rubber. Examples thereof include a liquid isoprene rubber, a liquid butadiene rubber, and polybutene (to be specific, liquid polybutene).

These liquid rubbers can be used alone or in combination.

Of the liquid rubbers, preferably, polybutene is used.

The polybutene has a kinetic viscosity at 40° C. of, for example, 10 to 200000 mm²/s, or preferably 1000 to 100000 mm²/s The polybutene has a kinetic viscosity at 100° C. of, for example, 2.0 to 4000 mm²/s, or preferably 50 to 2000 mm²/s.

The mixing ratio of the liquid rubber with respect to 100 parts by mass of the butyl rubber is, for example, 70 to 140 parts by mass, or preferably 80 to 120 parts by mass.

By blending the polybutene, the butyl rubber is capable of being softened.

Preferably, the sealing material 5 further contains a filler and a tackifier.

Examples of the filler include calcium carbonate (for example, heavy calcium carbonate, light calcium carbonate, Hakuenka, and the like), talc, mica, clay, mica powder, silica, alumina, aluminum silicate, titanium oxide, and glass powder (powder).

These fillers can be used alone or in combination.

Of the fillers, preferably, calcium carbonate is used.

The mixing ratio of the filler with respect to 100 parts by mass of the butyl rubber is less than 300 parts by mass, or preferably 250 parts by mass, and is, for example, 10 parts by mass or more, or preferably 30 parts by mass or more.

Examples of the tackifier include a rosin-based resin, a terpene-based resin (for example, a terpene-aromatic liquid resin and the like), a coumarone indene resin, and a petroleum resin (for example, a C5 petroleum resin and the like).

These tackifiers can be used alone or in combination.

Of the tackifiers, preferably, a petroleum resin such as a C5 petroleum resin (a C5 tackifier) is used.

The mixing ratio of the tackifier with respect to 100 parts by mass of the butyl rubber is, for example, 20 to 80 parts by mass, or preferably 40 to 60 parts by mass.

In addition to the above-described component, a cross-linking agent and furthermore, if necessary, a known additive can be also added to the sealing material 5 at an appropriate proportion. Examples of the known additive include a foaming agent, an anti-sagging agent (a thixotropic-imparting agent), a low-polarity rubber, a pigment, a thixotropic agent, a lubricant, an anti-scorching agent, a stabilizer, and an oxidation inhibitor.

Examples of the cross-linking agent include sulfur, a peroxide-based cross-linking agent, a metal chelate-based cross-linking agent, a quinoid cross-linking agent, an epoxy cross-linking agent, an isocyanate cross-linking agent, a metal salt-based cross-linking agent, a melamine cross-linking agent, an amino cross-linking agent, and a coupling agent-based cross-linking agent (a silane coupling agent or the like).

These cross-linking agents can be used alone or in combination.

Of the cross-linking agents, preferably, a quinoid cross-linking agent is used.

The mixing ratio of the cross-linking agent with respect to 100 parts by mass of the butyl rubber is, for example, 0.5 to 10 parts by mass, or preferably 1 to 5 parts by mass.

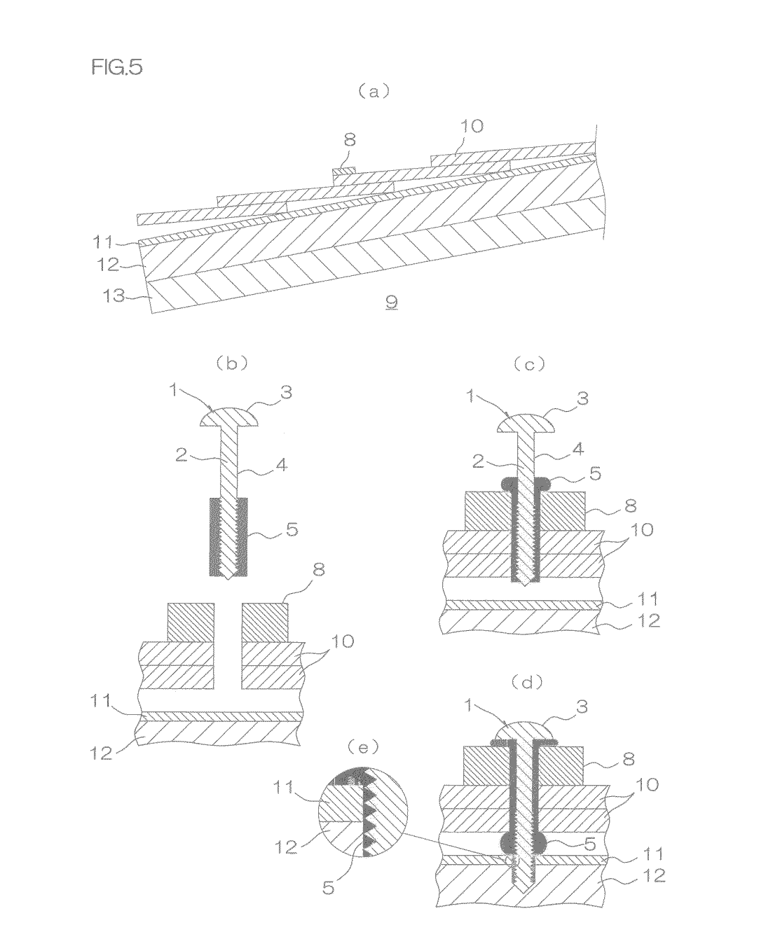

FIG. 2 shows a side view of one embodiment of a sealing material used in a waterproof screw of the present invention. FIGS. 3 and 4 show a side view of another embodiment of a sealing material used in a waterproof screw of the present invention.

Next, a method for fabricating the waterproof screw 1 of the present invention is described with reference to FIGS. 2 to 4.

In order to fabricate the waterproof screw 1, first, the sealing material 5 is prepared.

In order to prepare the sealing material 5, the above-described components are blended at the above-described mixing proportion and are kneaded with, though not particularly limited, for example, a mixing roll, a pressure kneader, an extruder, or the like, so that a pressure-sensitive adhesive composition is obtained.

When a cross-linking agent is added to the pressure-sensitive adhesive composition, the adding is performed at a temperature at which the pressure-sensitive adhesive composition is cross-linked in the above-described kneading or the following extension by applying pressure.

Thereafter, the obtained pressure-sensitive adhesive composition is extended by applying pressure by, for example, a calendering, an extrusion molding, a press molding, or the like to be laminated on the surface of a release paper 21 or the like as a pressure-sensitive adhesive layer 22. In this way, the sealing material 5 is prepared into a sheet shape.

The thickness of the pressure-sensitive adhesive layer 22 (the sealing material 5) is, for example, 0.5 to 5 mm, preferably 0.5 to 3 mm, or more preferably 0.5 to 1.5 mm

As shown in FIG. 3, the sealing material 5 can also include a support layer 6 so as to impart toughness to the sealing material 5.

The support layer 6 is laminated so as to be sandwiched between the two pressure-sensitive adhesive layers 22.

Examples of a material for forming the support layer 6 include a glass cloth, a resin impregnated glass cloth, a non-woven fabric, a metal foil, a carbon fiber, and a polyester film.

The glass cloth is cloth formed from a glass fiber and a known glass cloth is used.

The resin impregnated glass cloth is obtained by performing impregnation treatment of a synthetic resin such as a thermosetting resin and a thermoplastic resin into the above-described glass cloth and a known resin impregnated glass cloth is used. Examples of the thermosetting resin include an epoxy resin, a urethane resin, a melamine resin, and a phenol resin. Examples of the thermoplastic resin include a vinyl acetate resin, an ethylene-vinyl acetate copolymer (EVA), a vinyl chloride resin, and an EVA-vinyl chloride resin copolymer. The above-described thermosetting resins and thermoplastic resins can be used alone or in combination, respectively.

An example of the non-woven fabric includes a non-woven fabric formed of a fiber such as a wood fiber (a wood pulp and the like); a cellulose fiber (for example, a regenerated cellulose fiber such as rayon, a semi-synthetic cellulose fiber such as acetate, a natural cellulose fiber such as hemp and cotton, or a blended yarn thereof); a polyester fiber; a polyvinyl alcohol (PVA) fiber; a polyamide fiber; a polyolefin fiber; a polyurethane fiber; and a cellulose fiber (hemp, or hemp and another cellulose fiber).

An example of the metal foil includes a known metal foil such as an aluminum foil and a steel foil.

The carbon fiber is cloth formed from a fiber mainly composed of carbon and a known carbon fiber is used.

Examples of the polyester film include a polyethylene terephthalate film, a polyethylene naphthalate film, and a polybutylene terephthalate film. Preferably, a polyethylene terephthalate film is used.

Of the materials for forming the support layer 6, preferably, a non-woven fabric is used.

The thickness of the support layer 6 is, for example, 0.1 to 0.3 mm, or preferably 0.1 to 0.2 mm

When the thickness of the support layer 6 is above 0.3 mm, the winding properties of the sealing material may be reduced. When the thickness thereof is less than 0.1 mm, the productivity of the sealing material may be reduced.

In order to prepare the sealing material 5 including the support layer 6, the pressure-sensitive adhesive layer 22 is laminated on the surface of the release paper 21 or the like and thereafter, the above-described support layer 6 is attached to the surface that is the opposite side to the laminated side of the release paper 21 in the pressure-sensitive adhesive layer 22. Then, the pressure-sensitive adhesive layer 22 is laminated on the support layer 6 again.

As shown in FIG. 4, the sealing material 5 can also include an elastic layer 7 that is laminated on the pressure-sensitive adhesive layer 22.

The elastic layer 7 is not particularly limited as long as it imparts toughness to the sealing material 5. The elastic layer 7 is formed of, for example, a formed product of various rubbers.

Examples of a material for forming the elastic layer 7 include an ethylene-propylene-diene rubber (EPDM); an α-olefin such as 1-butene and dicyclopentadiene; a rubber-based copolymer containing a component of a cyclic or non-cyclic polyene having a non-conjugated double bond such as ethylidene norbornene; and various rubbers such as an ethylene-propylene rubber, an ethylene-propylene terpolymer, a silicone rubber, a polyurethane-based rubber, and a polyamide-based rubber.

Of the materials for forming the elastic layer 7, preferably, EPDM is used.

The EPDM has a Mooney viscosity of, for example, 10 to 60 (ML 1+4, 100° C.), or preferably 20 to 50 (ML 1+4, 100° C.).

The thickness of the elastic layer 7 is, for example, 0.1 to 1.0 mm, or preferably 0.3 to 0.8 mm.

In order to prepare the sealing material 5 including the elastic layer 7, the pressure-sensitive adhesive layer 22 is laminated on the surface of the release paper 21 or the like and thereafter, the elastic layer 7 is attached to the surface that is the opposite side to the laminated side of the release paper 21 in the pressure-sensitive adhesive layer 22.

Next, for example, the above-described sealing material 5 is wound around the shank portion 4 of the screw member 2 described above, so that the waterproof screw 1 is fabricated.

A method for winding the sealing material 5 around the shank portion 4 is not particularly limited and for example, the sealing material 5 is wound around the shank portion 4 so as to cover the screw thread (the screw groove) thereof along the outer circumference surface thereof. In this way, the sealing material 5 covers the circumference of the shank portion 4.

To be specific, in order to wind the sealing material 5 shown in FIG. 2 (the sealing material 5 in which the pressure-sensitive adhesive layer 22 is laminated on the release paper 21) and the sealing material 5 shown in FIG. 3 (the sealing material 5 in which the pressure-sensitive adhesive layer 22, the support layer 6, and the pressure-sensitive adhesive layer 22 are sequentially laminated on the release paper 21) around the shank portion 4, respectively, the sealing material 5 is wound around the shank portion 4 so that the release paper 21 is positioned at the outermost layer (the topmost surface) without peeling the release paper 21.

Thus, when the sealing material 5 shown in FIG. 2 is wound around the shank portion 4, the pressure-sensitive adhesive layer 22 is in contact with the screw thread (the screw groove) of the shank portion 4 and is also covered with the release paper 21. When the sealing material 5 shown in FIG. 3 is wound around the shank portion 4, the pressure-sensitive adhesive layer 22 that is the opposite side to the release paper 21 with respect to the support layer 6 is in contact with the screw thread (the screw groove) of the shank portion 4 and the pressure-sensitive adhesive layer 22 that is the same side as the release paper 21 with respect to the support layer 6 is covered with the release paper 21.

That is, in any one of cases where the sealing material 5 shown in FIG. 2 is wound around the shank portion 4 and where the sealing material 5 shown in FIG. 3 is wound around the shank portion 4, the pressure-sensitive adhesive layer 22 is covered with the release paper 21 and the release paper 21 is positioned at the topmost surface.

As a result, the waterproof screw 1 including the sealing material 5 shown in FIGS. 2 and 3 can suppress blocking (adhesion of the pressure-sensitive adhesive layers 22 to each other) of the waterproof screws 1 with each other at the time of transportation or the like.

On the other hand, in order to wind the sealing material 5 shown in FIG. 4 (the sealing material 5 in which the pressure-sensitive adhesive layer 22 and the elastic layer 7 are sequentially laminated on the release paper 21) around the shank portion 4, the sealing material 5 is wound around the shank portion 4 so that the elastic layer 7 is positioned at the outermost layer (the topmost surface) after peeling the release paper 21.

Thus, when the sealing material 5 shown in FIG. 4 is wound around the shank portion 4, the pressure-sensitive adhesive layer 22 is in contact with the screw thread (the screw groove) of the shank portion 4 and is also covered with the elastic layer 7. That is, the elastic layer 7 is positioned at the topmost surface.

As a result, also in the waterproof screw 1 including the sealing material 5 shown in FIG. 4, blocking (adhesion of the pressure-sensitive adhesive layers 22 to each other) of the waterproof screws 1 with each other can be suppressed at the time of transportation or the like.

In the waterproof screw 1 including the sealing material 5 shown in FIG. 4, the pressure-sensitive adhesive layer 22 is covered with the elastic layer 7 and does not expose at the topmost surface, so that it is possible to prevent the pressure-sensitive adhesive layer 22 from adhering to a hand of a user or the like at the time of an installation operation of installing a structure (described later) on a roof. Thus, the waterproof screw 1 including the sealing material 5 shown in FIG. 4 has an excellent handling ability.

In the waterproof screw 1 including the sealing material 5 shown in FIG. 4, the sealing material 5 is wound around the shank portion 4 after peeling the release paper 21, so that a step of peeling the release paper 21 can be omitted at the time of the installation operation of installing the structure (described later) on the roof. Thus, a smoother installation operation of the structure (described later) can be achieved.

At this time, the sealing material 5 covers the shank portion 4 in the axial direction of the shank portion 4 by 50 to 95%, or preferably 60 to 90%. To be specific, the sealing material 5 covers the shank portion 4 by 20 to 100 mm

To be more specific, the length of the screw member 2 is appropriately selected in accordance with the length of the insertion portion for the shank portion 4.

The sealing material 5 covers the shank portion 4 with a length longer than that of the insertion portion for the shank portion 4, for example, in the axial direction of the shank portion 4, with a length longer than that of the insertion portion for the shank portion 4 by 15 to 30 mm, or preferably 5 to 15 mm

The waterproof screw 1 can be used so as to install a structure 8 on, for example, a roof 9 of a building.

FIG. 5 shows explanatory views for illustrating one embodiment of a method for structure installation of the present invention in which a structure is installed on a roof of a building: (a): illustrating a step of disposing the structure on the roof (a structure disposing step) and (b) to (e): illustrating a step of fixing the structure to the roof by the waterproof screw shown in FIG. 1 (a structure fixing step).

In order to install the structure 8 on the roof 9, first, the structure 8 is disposed on the roof 9 (the structure disposing step).

The structure 8 is not particularly limited and an example thereof includes a fitting (a roof mount or the like) for fixing a solar cell module, an outdoor unit of air conditioner, or the like to the roof.

In the roof 9, for example, as shown in FIG. 5 (a), a roofing board 12 as a backing board is laminated on a rafter 13 and a roofing material 11 as a waterproof sheet is laminated on the roofing board 12. Slates 10 are disposed in step-like arrangement on the roofing material 11 and a space (a gap) is formed between the roofing material 11 and the slates 10.

The structure 8 is first disposed on the slate 10.

Next, the structure 8 is fixed to the roof 9 by the waterproof screw shown in FIG. 1 (the structure fixing step).

In order to fix the structure 8 to the roof 9, first, as shown in FIG. 5 (b), through holes are provided in the structure 8 and in the slates 10 of the roof 9 so as to allow the shank portion 4 of the screw member 2 to insert thereinto.

In the formation of the through holes, a known perforation method is used.

A prepared hole can be also provided in the roofing material 11 as required.

The diameter of each of the through holes is larger than that of the shank portion 4 and preferably, is smaller than the sum total of the diameter of the shank portion 4 and the thickness of the sealing material 5.

As shown in FIG. 5 (c), the shank portion 4 with its circumference covered with the sealing material 5 is allowed to insert into the through holes.

When the diameter of each of the through holes is smaller than the sum total of the diameter of the shank portion 4 and the thickness of the sealing material 5, a part of the sealing material 5 covering the circumference of the shank portion 4 is brought into contact with the upper surface of the structure 8 at the time of insertion. Thus, the sealing material 5 that is in contact with the upper surface of the structure 8 is not allowed to insert into the inside of the through hole and adheres to the upper surface of the through hole.

On the other hand, the sealing material that is not in contact with the upper surface of the structure 8 passes through the inside of the through holes, while covering the circumference of the shank portion 4, to then reach the space between the roofing material 11 and the slates 10.

Next, as shown in FIG. 5 (d), the waterproof screw 1 is screwed in. In this way, a screw hole is formed in the roofing material 11 and the shank portion 4 is screwed together with the roofing material 11 and the roofing board 12. In this way, the structure 8 is fixed to the roof 9 by the waterproof screw 1.

Thereafter, though not shown, a solar cell module, an outdoor unit of air conditioner, or the like is installed in the fitting.

As shown in FIG. 5 (e), at the time of screwing the shank portion 4 together with the roofing material 11 and the roofing board 12, the sealing material 5 that adheres to the screw thread (the screw groove) portion formed in the shank portion 4 is put into the inside of the screw hole with the shank portion 4, while covering the shank portion 4.

Thus, the sealing material 5 that adheres to the screw thread (the screw groove) portion is interposed between the shank portion 4, and the roofing material 11 and the roofing board 12 to seal a screwed portion for the shank portion 4.

On the other hand, at the time of forming the screw hole, the sealing material 5 that adheres to a portion other than the screw thread (the screw groove) portion is not put into the inside of the screw hole due to the resistance of the roofing material 11 and adheres to the upper surface of the screw hole. Thus, the upper surface of the screw hole is sealed.

The sealing material 5 that adheres to the upper surface of the through hole is sandwiched between the head portion 3 of the screw member 2 and the structure 8, so that it seals the upper surface of the through hole.

In this way, the upper surface of the through hole provided in the structure 8, the insertion portion and the screwed portion for the shank portion 4, and the upper surface of the screw hole formed in the roofing material 11 are sealed.

In this way, the waterproof screw 1 includes the screw member 2 including the head portion 3 and the shank portion 4 and the sealing material 5 covering the circumference of the shank portion 4, and the sealing material 5 has a shear storage elastic modulus G′ at 25° C. and a frequency of 1 Hz of 50000 Pa or less.

The sealing material 5 has an excellent adhesiveness to the shank portion 4 and therefore, even when the waterproof screw 1 is allowed to insert or is screwed together, the sealing material 5 is capable of sealing the insertion portion and the screwed portion without being peeled from the shank portion 4. Thus, as described above, when the structure 8 is fixed to the roof 9 using the waterproof screw 1, the sealing material 5 is capable of sealing the insertion portion and the screwed portion in the roof 9 for the shank portion 4 and furthermore, sealing the screw hole formed in the roofing material 11. As a result, the infiltration of water into the inside of the roof 9 is capable of being sufficiently suppressed.

Consequently, the above-described waterproof screw, sealing material, method for structure installation, and structure for structure installation are capable of fixing the structure to the roof and sufficiently suppressing the infiltration of water into the inside of the roof.

### EXAMPLES

The present invention will now be described in more detail by way of Examples and Comparative Examples. However, the present invention is not limited to the following Examples and Comparative Examples.

### Examples 1 to 4 and Comparative Examples 1 to 2

Pressure-sensitive adhesive compositions were obtained in accordance with the mixing formulation shown in Table 1 by blending the components and kneading the mixture (at 120° C. for 20 minutes) with a mixing roll.

Next, each of the obtained pressure-sensitive adhesive compositions was extended by applying pressure into a sheet shape by a press molding (at 120° C. for 10 minutes) to be laminated on the surface of the release paper 21, so that the sealing material 5 having a thickness of 1.0 mm was prepared.

Then, the sealing material 5 was wound around the shank portion 4 of the screw member 2 by one round so that the pressure-sensitive adhesive composition that was extended by applying pressure into a sheet shape (the pressure-sensitive adhesive layer 22) was in contact with the shank portion 4 of the screw member 2 and the release paper 21 was positioned at the outermost layer (the topmost surface). Thereafter, the release paper 21 was peeled from the sealing material 5, so that the waterproof screw 1 was fabricated. The length in the axial direction of the sealing material 5 was 20 mm

(Evaluation)

The viscoelasticity test of each of the sealing materials 5 obtained in Examples and Comparative Examples was performed as follows. Also, the screw adhesiveness test, the roofing material adhesiveness test, and the water stopping test of screw of each of the waterproof screws 1 obtained in Examples and Comparative Examples were performed as follows. The results are shown in Table 1.

(1) Viscoelasticity Test

Each of the sealing materials 5 obtained in Examples and Comparative Examples was processed into a cylindrical shape having a diameter of 7.9 mm to obtain test pieces. The shear storage elastic modulus G′ and the shear loss elastic modulus G″ at 25° C. of the obtained test pieces were calculated, respectively with a viscoelasticity measuring device (trade name: ARES, manufactured by Rheometric Scientific Inc.).

The measuring conditions were set to be as follows: a temperature rising rate of 5° C./min, a frequency of 1 Hz, and a distortion of 0.1%.

(2) Screw Adhesiveness Test

Each of the waterproof screws 1 obtained in Examples and Comparative Examples was allowed to pass through a laminated board of the roofing material 11 (a thickness of 2 mm) and the roofing board 12 (a thickness of 20 mm) to confirm the adhesiveness between the shank portion 4 of the screw member 2 that passed through thereto and the sealing material 5.

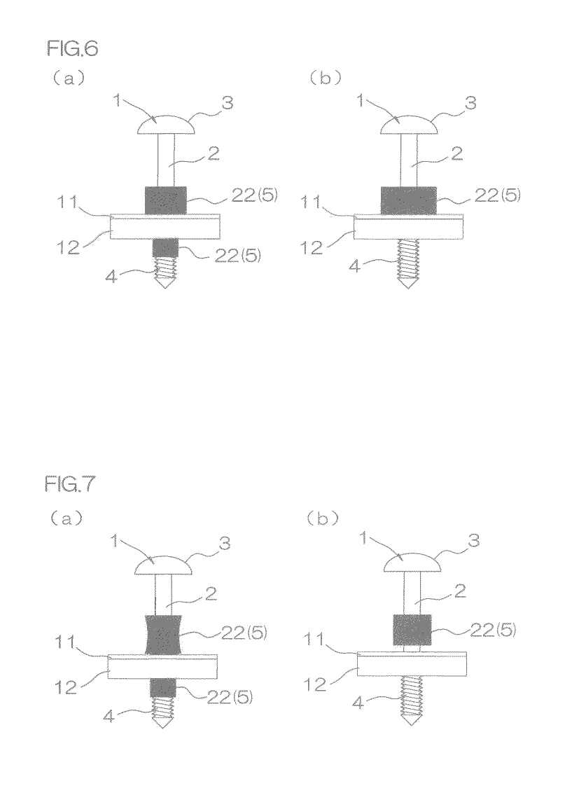

As shown in FIG. 6 (a), when the sealing material 5 covered the shank portion 4 of the screw member 2 that passed through the laminated board, the screw adhesiveness was defined as “Good”. As shown in FIG. 6 (b), when the sealing material 5 did not cover the shank portion 4 of the screw member 2 that passed through the laminated board, the screw adhesiveness was defined as “Bad”.

(3) Roofing Material Adhesiveness Test

Each of the waterproof screws 1 obtained in Examples and Comparative Examples was allowed to pass through a laminated board of the roofing material 11 (a thickness of 2 mm) and the roofing board 12 (a thickness of 20 mm) Thereafter, the waterproof screw 1 was screwed back to confirm the adhesiveness between the sealing material 5 and the roofing material 11.

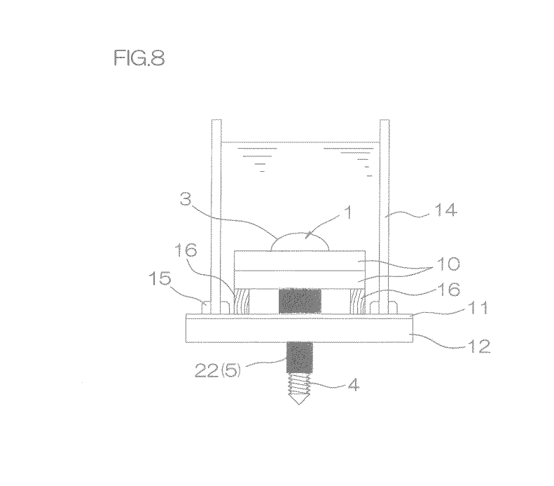

As shown in FIG. 7 (a), in a case where the sealing material 5 expanded and did not separate from the roofing material 11 even when the waterproof screw 1 was screwed back, the roofing material adhesiveness was defined as “Good”. As shown in FIG. 7 (b), in a case where the sealing material 5 separated from the roofing material 11 when the waterproof screw 1 was screwed back, the roofing material adhesiveness was defined as “Bad”.

(4) Water Stopping Test of Screw

As shown in FIG. 7, each of the waterproof screws 1 obtained in Examples and Comparative Examples was allowed to insert into the slates 10 (two pieces) (a thickness of 6 mm) in which through holes each having a diameter of 7 mm were provided to be then allowed to pass through a laminated board of the roofing material 11 (a thickness of 2 mm) and the roofing board 12 (a thickness of 20 mm) At this time, an interval of 6 mm was provided between the slates 10 and the roofing material 11 via wood block spacers 16. Next, a transparent acrylic tube 14 (a height of 20 mm and a diameter of 76 5 mm) was disposed on the laminated board so as to surround the head portion 3 of the screw member 2 and the slates 10. Then, the laminated board and the transparent acrylic tube 14 were bonded to each other by silicone caulking 15. Next, the inside of the transparent acrylic tube 14 was filled with water obtained by dissolving an aqueous ink therein so as to have a depth of 15 mm to be then allowed to stand for 24 hours.

24 hours later, the presence or absence of water leakage between the roofing material 11 and the roofing board 12 was confirmed to evaluate the water stopping performance of screw.

TABLE 1

| | | Ex. 1 | Ex. 2 | Ex. 3 | Ex. 4 | Comp. Ex. 1 | Comp. Ex. 2 |
|---|---|---|---|---|---|---|---|
| Mixing | Reclaimed | 100 | 100 | 100 | 100 | 100 | 100 |
| Formulation | Butyl Rubber | | | | | | |
| | Polybutene | 100 | 100 | 100 | 100 | 100 | 100 |
| | Calcium | 0 | 50 | 100 | 200 | 300 | 400 |
| | Carbonate | | | | | | |
| | C5 Tackifier | 50 | 50 | 50 | 50 | 50 | 50 |
| | Quinoid | 2 | 2 | 2 | 2 | 2 | 2 |
| | Cross-Linking | | | | | | |
| | Agent | | | | | | |
| Result of | Shear Storage | 27145 | 23190 | 16556 | 36217 | 58256 | 100846 |
| Evaluation | Elastic | | | | | | |
| | Modulus G′ | | | | | | |
| | (Pa) at 25° C. | | | | | | |
| | Shear Loss | 13978 | 11949 | 10157 | 17393 | 26489 | 46547 |
| | Elastic | | | | | | |
| | Modulus G″ | | | | | | |
| | (Pa) at 25° C. | | | | | | |
| | Screw | Good | Good | Good | Good | Bad | Bad |
| | Adhesiveness | | | | | | |
| | Roofing | Good | Good | Good | Good | Bad | Bad |
| | Material | | | | | | |
| | Adhesiveness | | | | | | |
| | Water | Absence of | Absence of | Absence of | Absence of | Presence of | Presence of |
| | Stopping Test | Water | Water | Water | Water | Water | Water |
| | of Screw | Leakage | Leakage | Leakage | Leakage | Leakage | Leakage |
| | (24 hours) | | | | | | |

Abbreviations of the components in Table 1 are shown in the following.

Reclaimed butyl rubber: a Mooney viscosity of 44 (±6) (ML 1+4, 100° C.)

Polybutene: a kinetic viscosity of 600 mm²/s (at 100° C.)

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### Industrial Applicability

The waterproof screw, the sealing material, the method for structure installation, and the structure for structure installation of the present invention can be used to install a structure on a roof of a building or the like.

1. A waterproof screw comprising:
a screw member including a head portion and a shank portion and
a sealing material covering the circumference of the shank portion, wherein
the sealing material has a shear storage elastic modulus G′ at 25° C. and a frequency of 1 Hz of 50000 Pa or less.

2. The waterproof screw according to claim 1, wherein
the waterproof screw is used so as to install a structure on a roof.

3. The waterproof screw according to claims 1 and 2, wherein
the sealing material contains a butyl rubber and a liquid rubber.

4. The waterproof screw according to claim 3, wherein
the sealing material further contains a filler and
the mixing ratio of the filler with respect to 100 parts by mass of the butyl rubber is less than 300 parts by mass.

5. The waterproof screw according to claim 3, wherein
the sealing material further contains a tackifier.

6. A sealing material covering a shank portion of a screw member to be used so as to seal an insertion portion for the shank portion, wherein
the sealing material has a shear storage elastic modulus G′ at 25° C. and a frequency of 1 Hz of 50000 Pa or less.

7. A method for structure installation, installing a structure on a roof, comprising:
a structure disposing step of disposing the structure on the roof and
a structure fixing step of fixing the structure to the roof by a waterproof screw, wherein the waterproof screw comprises:
a screw member including a head portion and a shank portion and
a sealing material covering the circumference of the shank portion, and
the sealing material has a shear storage elastic modulus G′ at 25° C. and a frequency of 1 Hz of 50000 Pa or less.

8. A structure for structure installation in which a structure is installed on a roof, wherein
the structure is disposed on the roof and
the structure is fixed to the roof by a waterproof screw, and
the waterproof screw comprises:
a screw member including a head portion and a shank portion and
a sealing material covering the circumference of the shank portion, and
the sealing material has a shear storage elastic modulus G′ at 25° C. and a frequency of 1 Hz of 50000 Pa or less.
